(19) United States
(12) Patent Application Publication
(10) Pub. No.: US 2021/0146478 A1
(43) Pub. Date: May 20, 2021

(54) LASER WELDING METHOD AND DEVICE

(71) Applicant: Rofin-Sinar Laser GmbH, Hamburg (DE)

(72) Inventors: Oliver FORSTER, Güster (DE); Peter KALLAGE, Hamburg (DE); Jens SCHÜTTLER, Hamburg (DE)

(73) Assignee: Rofin-Sinar Laser GmbH, Hamburg (DE)

(21) Appl. No.: 17/045,947

(22) PCT Filed: Mar. 19, 2019
(86) PCT No.: PCT/EP2019/056839

§ 371 Date: Oct. 7, 2020

(30) Foreign Application Priority Data
Apr. 13, 2018 (DE) 102018108824.8

(51) Int. Cl. B23K 26/24; B23K 26/14

(52) U.S. Cl. CPC B23K 26/24; B23K 26/1436

(57) ABSTRACT

The invention relates to a method for laser welding workpieces (W), a laser beam (L) directed onto a workpiece surface having such a radiation intensity that the workpiece material of the at least one workpiece (W) to be welded is melted in the region of the laser focus (F), a vapor capillary (D) which is at least partly surrounded by a molten bath (S) forming in the region of the laser focus (F). The laser beam (L) is moved relative to the workpiece surface in a direction of advance (V) in order to produce a weld seam. According to the invention, the molten bath (S) is subjected to mechanical stress by directing a gas stream (G) onto the workpiece surface for the purpose of stabilization during welding. The invention further relates to a device (1) designed for carrying out said method.

The invention relates to a method and a device for laser welding.

The invention relates in particular to a method for laser welding of workpieces, wherein a laser beam oriented onto a workpiece surface has a radiation intensity such that the workpiece material of the at least one workpiece to be welded is melted in the region of a laser focus. A vapor capillary forms in this case in the region of the laser focus, which enclosed at least in sections by a liquid molten pool. To produce a weld seam, the laser focus is moved in relation to the workpiece surface in a feed direction.

The invention furthermore relates to a device for laser welding having a carrier for at least one workpiece to be welded, a laser source, and a laser optical unit for generating a laser beam oriented in a laser focus onto a workpiece surface, and a gas supply for producing a gas flow oriented onto the at least one workpiece surface. At least the laser optical unit and the carrier are movably mounted in relation to one another in such a way that the laser focus can be guided at least over a section of the at least one workpiece surface in the feed direction.

Laser welding, i.e., the welding of one or multiple, in particular metallic workpieces with the aid of laser radiation, is routine prior art. In general, for this purpose a laser beam is oriented or focused on a workpiece surface and the workpiece material is locally melted in the region of the laser focus. The laser beam typically has a high radiation intensity, so that a welding capillary or vapor capillary (English: “keyhole”) forms in the region of the laser focus, from which metal vapor escapes. The vapor capillary is enclosed at least around the edge with liquid molten material. To form a weld seam, the laser beam is moved in relation to the workpiece surface.

For welding using laser radiation, it is routine to introduce an inert gas, for example, helium (He) argon (Ar), or nitrogen (N₂) into the surroundings of the welding capillary, with the goal of displacing the ambient air and in particular the air oxygen and thus avoiding oxidation of the weld seam. For this purpose, the inert gas is typically introduced using a nozzle, which is oriented at a flat angle with respect to the workpiece surface. The nozzle typically produces a protective gas flow or inert gas flow which extends at an angle of 0°-30° with respect to the workpiece surface. In applications in which the laser beam extends perpendicularly to the workpiece surface, this thus corresponds to an angle of 60° to 90° with respect to the beam direction or with respect to the optical axis of the laser optical unit which focuses the laser beam on the workpiece surface or at least on a region close to the workpiece surface. In any case, the gas supply is designed at such a way that no or at most a minor dynamic pressure results at the location of the molten pool. This is typically performed via a corresponding alignment and dimensioning of the nozzle, which is used for providing the inert gas flow. The goal is to influence the molten pool as little as possible.

Problems increasingly occur in particular in fiber-guided laser systems due to the different absorption characteristic as a function of the wavelength, such as spatters, pores, and a mass loss connected thereto, which negatively influence the quality of the produced weld seam. To remedy these problems, a variety of different measures have already been provided, which are based, for example, on a modification of the intensity distribution on the workpiece surface, for example, by way of the use of multiple focuses, double spots, or the like.

Another procedure was fundamentally presented by Fabbro et al. in “Experimental study of the dynamical coupling between the induced vapour plume and the melt pool for Nd-Yag CW laser welding”, Journal of Physics D: Applied Physics, Vol. 39 (2006), pages 394-400. In addition to a study of the alignment and dimensions of the capillary wall (English: “keyhole wall”), a stabilization of the turbulent molten pool at very low feed speeds was achieved by application of an inert gas flow which is incident on the workpiece surface at an angle of approximately 45°.

However, it is known from Fabbro et al.: “Melt Pool and Keyhole Behaviour Analysis for Deep Penetration Laser Welding”, Journal of Physics D: Applied Physics Vol. 43 (2010), pages 445-501 that the hydrodynamic behavior of the molten pool formed during deep welding processes is critically dependent on the feed speed at which the laser focus is moved in relation to the workpiece surface. In the range of low feed speeds of up to 5 m/min, the so-called “Rosenthal” regime exists, which is characterized by a relatively large molten pool having strong surface fluctuations. In other ranges, in particular at higher feed and/or welding speeds, the flow conditions are significantly influenced by other physical effects. The hydrodynamic behavior of the coupled system made up of vapor capillary and molten pool then already qualitatively differs from the “Rosenthal” regime.

It is the object of the present invention to specify measures for improving the quality of weld seams produced by means of laser welding, which can be applied in a broad range of welding and/or feed speeds.

The above-mentioned object is achieved with respect to the method by a method for laser welding having the features of claim 1.

The above-mentioned object is achieved with respect to the device by a device for laser welding having the features of claim 7.

Advantageous designs of the invention are the subject matter of the dependent claims.

In a method for laser welding of workpieces, a laser beam is oriented onto a workpiece surface. The laser beam has a radiation intensity such that the workpiece material of the at least one workpiece to be welded is melted in the region of a laser focus. A welding capillary or vapor capillary (English: “keyhole”) forms in this case in the region of the laser focus, which is enclosed at least in sections, in particular circumferentially, by a liquid molten pool. The laser focus is moved in a feed direction in relation to the workpiece surface to produce a weld seam. According to the invention, the molten pool is mechanically stressed by application of a gas flow oriented onto the workpiece surface for stabilization during the welding process.

The core of the invention is thus the finding that a mechanical stress of the molten pool, i.e., a force action on the molten pool during the welding process, surprisingly effectuates stabilization thereof. This results in particular in reduced formation of spatters and pores and—linked thereto—less material loss. The quality of the weld seam produced can thus be significantly improved by the gas being applied in such a way, contrary to the common teaching, that a non-negligible force is exerted on the molten pool. In routine welding methods, an inert gas flow or protective gas flow is dimensioned and oriented in such a way that oxygen is displaced from the immediate surroundings of the laser focus, but influencing of the molten pool by the inert gas flow is avoided simultaneously.

A mechanical stress of the molten pool is achieved in particular if the application of gas takes place essentially in the direction of a beam axis or an optical axis associated with the laser beam. Depending on the type of joint of the welded bond, it is thus appropriate to impinge the molten pool at a steep angle, i.e., for example, in a direction which does not deviate or only deviates slightly from a surface normal extending perpendicularly to the workpiece surface at the location of the laser focus. The goal is to achieve a non-negligible application of force.

The gas applied to the workpiece is, for example, a protective gas or inert gas, such as a noble gas, in particular helium (He) or argon (Ar), or another inert gas, such as nitrogen (N₂). In other areas of application, in particular if oxidation of the weld seam does not play a role or only plays a reduced role, applying compressed air or oxygen (O₂) to the molten pool is provided.

The location or the region of the laser focus is to be understood in the scope of this specification in particular such that substantially the region is hereby comprised in which the laser beam is incident on the material surface. In particular in the laser welding of plates, it is routine to focus the laser beam at a focal point which is located slightly above or below the workpiece surface. In this case, a convergent or divergent beam field is thus provided at the workpiece surface. In other words, the scope of this invention also comprises designs in which the radiation field assumes a minimal cross-sectional extension at a focal point, which is slightly spaced apart from the workpiece surface, in particular by a few plate thicknesses.

According to the invention, the laser beam is moved in relation to the workpiece surface in the feed direction at a feed speed to produce the weld seam and a hydrodynamic dynamic pressure of the gas flow applied to the workpiece is set as a function of the feed speed in such a way that the hydrodynamic dynamic pressure is at least half as much and at most four times as much as a reference dynamic pressure selected proportionally to the feed speed. The reference dynamic pressure pₛ is given as a function of the feed speed v_{w} by the relationship

pₛ=k*v_{w}

wherein the proportionality factor k in the SI unit system is k=7.2*10³ Pa s/m. In other words, the reference dynamic pressure pₛ specified in Pascal is 120 times the feed speed v_{w} specified in m/min (meters per minute). The molten pool may be stabilized in a variety of different applications using a gas flow dimensioned in this way.

In one design, the application of gas to the molten pool is performed by means of a gas flow oriented in the feed direction or against the feed direction. The flow direction of the supplied gas flow extends at an angle which is less than 35° with respect to an optical axis associated with the laser beam. In these terms it is thus proposed in particular that a nozzle providing the gas flow be set relatively steep in relation to the workpiece surface in particular, to effectuate a force oriented onto the surface of the molten pool.

The optical axis associated with the laser beam is defined in particular by the geometry of a laser optical unit focusing the laser beam.

In one design, the application of gas to the molten pool is performed by means of a gas flow oriented in the feed direction which extends at an angle less than 10° with respect to the optical axis. In one possible application, the flow direction of the gas flow is oriented “piercing” in the feed direction at a small angle of up to 10° when the laser beam is correspondingly oriented perpendicularly to the surface of a workpiece to be welded.

Alternatively or additionally, the application of gas to the molten pool is performed by means of a gas flow oriented against the feed direction, i.e. “trailing”. The “trailing” application taking place against the feed direction is preferably performed at an angle which is less than 30° with respect to the optical axis associated with the laser beam.

In one refinement, an application of gas to the melt pool is performed simultaneously with at least one gas flow oriented in the feed direction and at least one further gas flow oriented against the feed direction. In this context, it is provided in particular that the gas supply has at least two nozzles for providing gas flows, which are accordingly oriented in the feed direction or against the feed direction, respectively.

In one design, the application of gas to the workpiece surface takes place essentially in the direction of the laser beam or the optical axis. In particular with perpendicular alignment of the laser beam on the workpiece surface, the application of gas to the molten pool thus takes place perpendicularly to the workpiece surface, i.e., in the direction of the surface normal at the location of the laser focus.

In one design, the laser beam is oriented at least approximately perpendicular to the workpiece surface, i.e., in the direction of the surface normal at the location of the laser focus. The laser beam is preferably oriented in this context in a beam direction on the workpiece surface which differs by less than 5° with respect to the surface normal at the location of the laser focus.

In a deviation from this, for example, if a fillet seam is to be produced, the laser beam can also be set at a greater angle with respect to the workpiece surfaces.

In one design, the application of gas to the workpiece surface takes place coaxially to the beam direction of the laser beam. For such designs, it is provided in particular that devices be used for laser welding, the gas supplies of which define flow directions which extend coaxially to an optical axis of a laser optical unit, which orients the laser beam in the beam direction on the workpiece surface. Such embodiments advantageously have a certain directional independence, since a complex reorientation of the nozzles providing the gas flow can be omitted in particular in the case of weld seams to be produced having nonlinear profile in or against the feed direction.

In one design, the gas flow is oriented on the workpiece surface in a region around the laser focus, the radius of which is at most twice a nozzle orifice diameter of a nozzle providing the gas flow. In other words, the gas flow is deliberately oriented onto a limited region of the workpiece surface in which the molten pool containing the liquid molten material is to be found, in particular to exert a force on its surface. The targeted alignment of the gas flow on the region around the laser focus ensures that the interaction with the gas flow is not exclusively restricted to the deflection of a plasma plume possibly formed in the region of the vapor capillary. The gas flow accumulates in the region of the molten pool or forms a pronounced accumulation point there.

In one design, it is provided that the gas flow has a volume flow which is suitably adapted in particular as a function of a flow cross section of the gas supply. The flow cross section is limited, for example, by the nozzle orifice diameter of a nozzle providing the gas flow. The gas flow flowing through the flow cross section is very generally dimensioned such that on one hand, a non-negligible force is exerted on the molten pool, on the other hand, expulsion of material from the molten pool is at least substantially avoided.

In one design, the dimensioning of the gas flow is performed under the assumption that the hydrodynamic dynamic pressure p_{d} is given by the density p and a flow speed v_{g} of the gas by way of the relationship p_{d}=½ρ*v_{g}². Furthermore, in one design it is assumed that the flow speed v_{g} results according to v_{g}=VS/A, from the quotient of the volume flow VS and the flow cross section A through which the volume flow VS flows. The flow cross section is defined, for example, by the size of an in particular adjustable nozzle orifice opening of a nozzle or an in particular adjustable flow opening of a throttle or a reduction, through which the gas flow flows.

In one design, the feed speed is greater than 5 m/min, in particular at least 6 m/min. The above-described measures are suitable in particular for effectuating an improvement in welding processes in which the molten pool does not have hydrodynamic behavior characteristic of the so-called Rosenthal regime.

A device for laser welding is designed to carry out the above-described method. The device for laser welding, in particular deep welding, comprises a carrier for at least one workpiece to be welded, a laser source, in particular a fiber-guided laser, gas laser, solid-state laser, or fiber laser, and a laser optical unit for generating a laser beam oriented onto a workpiece surface and a gas supply, in particular having one or more nozzles, for producing a gas flow oriented onto the at least one workpiece surface. At least the laser optical unit and the carrier are movably mounted in relation to one another in such a way that the laser beam can be guided at least over a section along the workpiece surface in the feed direction. According to the invention, the gas supply is designed to mechanically stress a molten pool formed in the region of a laser focus by application of gas. The advantageous effects on the welding process linked thereto may be derived directly from the above description with respect to the corresponding method for laser welding, so that reference is made to the previous statements.

In one design, the gas supply for providing the gas flow has at least one nozzle oriented on the workpiece surface in the feed direction or against the feed direction. The nozzle can be aligned or is aligned with respect to an optical axis of the laser optical unit. The nozzle can be aligned with respect to the optical axis in particular adjustably at an angle which is less than 30° with respect to the optical axis. In another exemplary embodiment, the nozzle is aligned at an angle of less than 30° with respect to the optical axis. The device for laser welding, in particular a processing head comprising at least the nozzle and the laser optical unit, is thus designed for the purpose and arranged with respect to the carrier for the workpiece to be welded such that the application of gas can take place with corresponding orientation of the optical axis at a steep angle with respect to the workpiece surface, i.e., for example, essentially along a surface normal extending perpendicularly to the workpiece surface, in order to mechanically stress the molten pool during the welding process.

In one design, a nozzle oriented in the feed direction can be aligned or is aligned with respect to the optical axis at an angle which is less than 10°. Alternatively or additionally, a nozzle oriented against the feed direction can be aligned or is aligned with respect to the optical axis at an angle which is less than 30°. It has been shown that in general with “piercing” application, i.e., with application of a gas flow to the workpiece which is oriented in the feed direction, smaller angles of attack are preferred than in the case of a “trailing” processing, i.e., taking place against the feed direction.

In one design, an optical axis of the laser optical unit orienting the laser beam on the workpiece surface can be aligned or is aligned at an angle which is less than 5° with respect to a surface normal extending perpendicular to the workpiece surface at the location of the laser focus. In other words, the device for laser welding is embodied in such a way that the laser optical unit can be oriented in particular with respect to the carrier in such a way that the provided, in particular focused laser beam can be oriented, for example, essentially in parallel to the surface normal on the workpiece.

The at least one nozzle is preferably rotatably mounted with respect to an axis extending perpendicularly to the workpiece surface, so that the nozzle can also always be oriented in or opposite to the feed direction in the case of weld seams to be produced which do not have a linear course.

In one design, the gas supply has at least one nozzle, which is aligned coaxially to an optical axis of the laser optical unit, so that the gas flow provided by the nozzle for application to the workpiece can be aligned or is aligned in particular coaxially to the laser beam in the direction of a surface normal extending perpendicularly to the workpiece surface at the location of the laser focus. Coaxial processing heads having a gas supply oriented with respect to the laser optical unit in this way are advantageously designed as direction independent, since, at least if the optical axis of the laser optical unit is aligned perpendicular to the workpiece surface during the processing, they do not have to be rotated in order to position the gas flow provided by the nozzle suitably in or against the feed direction.

In one design of exemplary embodiments having a gas supply guided coaxially to the optical axis, it is provided that the at least one nozzle has a nozzle orifice surface, which limits the flow cross section, is in particular in the form of a circle or circular ring, and is preferably adjustable. This nozzle orifice surface is arranged coaxially to the optical axis of the laser optical unit. In other words, the optical axis of the laser optical unit extends, for example, directly through a nozzle providing the gas flow having a circular nozzle orifice surface. Alternatively thereto, the nozzle is designed as a ring nozzle having nozzle orifice surface in the form of a circular ring, which is arranged concentrically with respect to the optical axis.

In one design, the device for laser welding has a control unit having a control routine implemented therein for automatically setting the gas supply as a function of the feed speed, in particular for automatically setting a hydrodynamic dynamic pressure of the gas flow provided by the gas supply is a function of the feed speed according to one of the above-described methods. It is provided in particular for this purpose that the control unit is operationally connected to an actuator limiting the flow cross section, such as a nozzle, or a reduction having adjustable flow cross section.

In one refinement, it is provided that the gas flow, in particular the dynamic pressure induced by the gas flow, is actively controlled by means of the control unit during the welding process as a function of the feed speed in accordance with the above-described procedure.

In one design, the laser source has a laser power of at least 3 kW, for example, approximately 4 kW or 4.5 kW.

In one design, the laser source is designed to provide laser radiation having a wavelength of less than 10 μm, in particular less than 5 μm, preferably less than 2 μm, particularly preferably between 350 nm and 1300 nm. This laser source is preferably a fiber-guided laser.

Possible exemplary embodiments of the invention are explained in greater detail hereinafter with reference to the drawings. In the figures:

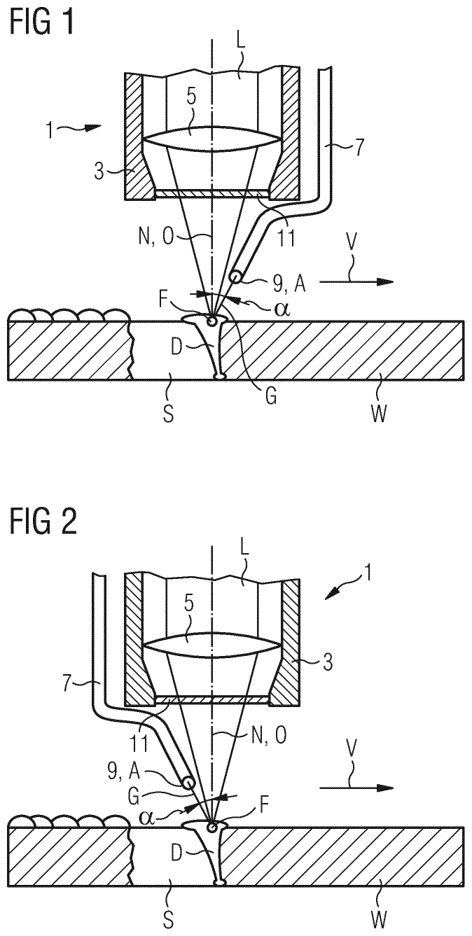

FIG. 1: shows a device for laser welding having a gas supply oriented against a feed direction for mechanically stressing a molten pool in a sectional illustration;

FIG. 2: shows a device for laser welding having a gas supply oriented in the feed direction for mechanically stressing a molten pool in a sectional illustration;

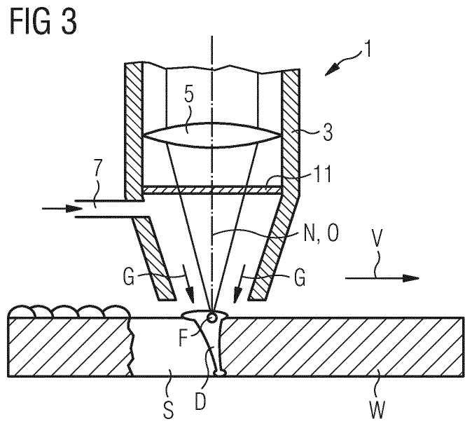

FIG. 3: shows a device for laser welding having a gas supply oriented coaxially to an optical axis for mechanically stressing a molten pool in a sectional illustration.

Parts corresponding to one another are provided with the same reference signs in all figures.

FIGS. 1 and 2 schematically illustrate a first embodiment of a device 1 for laser welding, which is designed for the purpose of mechanically stressing a molten pool S formed during the welding procedure, in particular deep welding.

The device 1 has a processing head 3, which has at least one laser optical unit 5 focusing a laser beam L and a gas supply 7 having nozzle 9. A laser source (not shown in greater detail), for example, a solid-state laser or fiber laser, generates the laser beam L. An optical axis O of the laser optical unit 5 is oriented essentially perpendicularly to a workpiece surface of a workpiece W to be welded. The laser optical unit 5 orients the laser beam L onto the workpiece W, wherein the laser optical unit 5 is protected by a window 11 during the processing. The laser focus F of the laser beam L is located in the schematically illustrated example in the vicinity of the workpiece surface and generates there, due to the high intensity of the provided laser beam L, a vapor capillary D having plasma plume. The vapor capillary D is located in the molten pool S, i.e., it is enclosed by liquid molten material. The workpiece W is furthermore fixed on a carrier (not shown in greater detail), which is movably mounted relative to the processing head 3 in such a way that the workpiece W can be guided the feed direction V in relation to the provided laser beam L to produce a weld seam.

At least the gas supply 7 having nozzle 9 is rotatably mounted with respect to the optical axis O, so that it is possible to orient the gas supply 7 correspondingly, as shown in FIG. 1, to produce a gas flow G oriented against the feed direction V or, as shown in FIG. 2, to produce a gas flow G oriented in the feed direction V. The nozzle 9 is oriented in the illustrated example at an angle α of approximately 25° with respect to the optical axis O. Since the laser beam L is oriented perpendicularly on the workpiece surface, this corresponds to an application to the molten pool S at an angle α of approximately 25° with respect to a surface normal N extending perpendicularly to the workpiece surface at the location of the laser focus.

FIG. 3 shows the schematic structure of a second embodiment of a device 1 for laser welding, which is designed to mechanically stress the molten pool S formed during the welding process. The device 1 for laser welding differs structurally from the first exemplary embodiment shown in FIGS. 1 and 2 solely with respect to the geometry of the gas supply, so that reference is made to the description in this regard.

The processing head 3 of the second exemplary embodiment is designed as a coaxial head, i.e., the gas supply 7 having nozzle 9 produces a gas flow G, which extends coaxially to the optical axis O. With perpendicular alignment of the laser beam L on the workpiece surface, the gas flow G is thus applied to the molten pool G essentially in the direction of the surface normal N, i.e., at an angle α of approximately 0°.

In a method for laser welding, the laser beam L is guided along the workpiece surface in the feed direction V to locally melt the workpiece material in the region of the laser focus F. The feed speed v_{w} along the feed direction V is in particular 1 m/min to 50 m/min, for example, 4 m/min to 24 m/min. The angle α, at which the gas flow G is incident on the molten pool S, is preferably between 0° and 35°. A nozzle orifice surface of the nozzle 9 limiting the flow cross section A of the gas flow G has, for example, a diameter of a few millimeters, in particular less than 4 mm, for example, approximately 3 mm. The nozzle orifice surface is typically spaced apart several millimeters, for example, between approximately 5 mm and 15 mm, from the welding capillary or vapor capillary D.

The application to the molten pool is to take place with a force which is suitable for stabilizing it, but expelling material at least to a noticeable extent is also to be avoided. The hydrodynamic pressure pₜ has proven to be a suitable parameter for the dimensioning of the gas flow G, which may be computed in simplified form from the density ρ and the flow speed v_{g} of the outflowing gas according to p_{d}=½ρ*v_{g}². The flow velocity v_{g} can be derived in simplified form from the relationship v_{g}=VS/A, wherein VS denotes the volume flow of the gas flow G through the flow cross section A. The volume flow VS in typically dimensioned nozzles is several liters per minute (1/min).

The gas flow for mechanically stressing the molten pool S is preferably set such that the produced hydrodynamic dynamic pressure p_{d} is within an interval around a reference dynamic pressure pₛ. The gas flow is set as a function of the type of gas, nozzle orifice opening surface, and feed speed v_{w} in such a way that the dynamic pressure p_{d} is at least half as much as a reference dynamic pressure pₛ and at most four times as much as the reference dynamic pressure, i.e. (0.5*pₛ<p_{d}<4*pₛ).

The reference dynamic pressure pₛ is given by pₛ=k*v_{w}, wherein the proportionality factor (k) in the SI unit system is k=7.2*10³ Pa s/m.

In a specific exemplary embodiment, a stainless steel plate of the thickness 1.5 mm is welded. A fiber-guided laser provides a laser beam L of 4.5 kW. The laser optical unit 5 used has, for example, an imaging ratio of 120:300 and images a 200 μm fiber diameter on the workpiece surface, so that a laser focus having spot diameter of approximately 0.5 mm results there. At a feed speed v_{w} of 12 m/min, argon is applied to the molten pool. The provided gas flow has a volume flow of 20 L/min, which is limited by a nozzle 9, the diameter of which is 3 mm. This corresponds to a hydrodynamic dynamic pressure p_{d} of approximately 2 kPa, i.e., approximately 1.38 times the reference dynamic pressure pₛ.

The invention was described above with reference to preferred exemplary embodiments. However, it is apparent that the invention is not restricted to the specific design of the exemplary embodiments shown, rather a person of relevant skill in the art can derive variations on the basis of the description without deviating from the essential basic concept of the invention.

### LIST OF REFERENCE SIGNS

1 device
3 processing head
5 laser optical unit
7 gas supply
9 nozzle
11 window
O optical axis
L laser beam
W workpiece
S molten pool
D vapor capillary
V feed direction
G gas flow
α angle
A flow cross section

1. A method for laser welding of workpieces (W), wherein a laser beam (L) oriented onto a workpiece surface has a radiation intensity such that the workpiece material of the at least one workpiece (W) to be welded is melted in the region of a laser focus (F), wherein a vapor capillary (D) forms in the region of the laser focus (F), which is enclosed at least in sections by a liquid molten pool (S), wherein the laser beam (L) is moved in relation to the workpiece surface in a feed direction (V) to produce a weld seam, wherein the molten pool (S) is mechanically stressed for stabilization during the welding process by application of a gas flow (G) oriented onto the workpiece surface, characterized in that the laser beam (L) is moved in relation to the workpiece surface in the feed direction (V) at a feed speed (v_{w}) to produce the weld seam and a hydrodynamic dynamic pressure (p_{d}) of the gas flow (G) applied to the workpiece (W) is set as a function of the feed speed (v_{w}) in such a way that the hydrodynamic dynamic pressure (p_{d}) is at least half as much and at most four times as much as a reference dynamic pressure (pₛ) selected proportionally to the feed speed (v_{w}), which is given by the relationship pₛ=k*v_{w}, wherein the proportionality factor k in the SI unit system is k=7.2*10³ Pa s/m.

2. The method as claimed in claim 1, characterized in that the application of gas to the molten pool (S) is performed by means of a gas flow (G) oriented in the feed direction (V) or against the feed direction (V), wherein the flow direction of the gas flow (G) extends at an angle (α), which is less than 35°, with respect to an optical axis (O) associated with the laser beam (L).

3. The method as claimed in claim 2, characterized in that the application of gas to the molten pool (S) is performed by means of a gas flow (G) oriented in the feed direction (V), which extends at an angle (α), which is less than 10°, with respect to the optical axis (O), and/or the application of gas to the molten pool (S) is performed by means of a gas flow (G) oriented against the feed direction (V), which extends at an angle (α), which is less than 30°, with respect to the optical axis (O).

4. The method as claimed in claim 1, characterized in that the gas flow is oriented onto a region around the laser focus (F), the radius of which is at most twice a nozzle orifice diameter of a nozzle (9) providing the gas flow (G).

5. The method as claimed in claim 1, characterized in that the hydrodynamic dynamic pressure (p_{d}) is given by density (ρ) and a flow speed (v_{g}) of the gas by way of the relationship p_{d}=½ρ*v_{g}², wherein the flow speed (v_{g}) results according to vg=VS/A, from the quotient of a volume flow (VS) of the gas flow (G) and a flow cross section (A), through which the volume flow (VS) flows.

6. The method as claimed in claim 1, characterized in that the feed speed (v_{w}) is greater than 5 m/min, in particular at least 6 m/min.

7. A device (1) for laser welding, which is designed to carry out a method as claimed in any one of the preceding claims, comprising
a carrier for at least one workpiece (W) to be welded,
a laser source and a laser optical unit (5) for generating a laser beam (L) oriented onto a workpiece surface,
a gas supply (7) for producing a gas flow (G) oriented onto the at least one workpiece surface, wherein at least the laser optical unit (5) and the carrier are movably mounted in relation to one another in such a way that the laser beam (L) can be guided at least over a section along the workpiece surface in the feed direction (V), characterized in that the gas supply (7) is designed to mechanically stress a molten pool (S) formed in the region of a laser focus (F) by application of gas.

8. The device (1) as claimed in claim 7, characterized in that the gas supply (7) has at least one nozzle (9) oriented onto the workpiece surface in the feed direction (V) or against the feed direction (V) to provide the gas flow (G), wherein the nozzle (9) is aligned or can be aligned at an angle (α), which is less than 30°, with respect to an optical axis (O) of the laser optical unit (5).

9. The device (1) as claimed in claim 8, characterized in that the nozzle (9) oriented in the feed direction (V) is aligned at an angle (α), which is less than 10°, with respect to the optical axis (O) and/or the nozzle (9) oriented against the feed direction (V) is aligned or can be aligned at an angle (α), which is less than 30°, with respect to the optical axis (O).

10. The device (1) as claimed in claim 7, characterized in that the gas supply (7) has a nozzle (9), which can be aligned or is aligned coaxially to an optical axis (O) of the laser optical unit (5).

11. The device (1) as claimed in claim 10, characterized in that the nozzle (9) has a nozzle orifice surface, which delimits a flow cross section (A) and is in particular in the form of a circle or circular ring, and which is arranged coaxially to the optical axis (O) of the laser optical unit (5).

12. The device (1) as claimed in claim 7, characterized by a control unit having a control routine implemented therein for automatically setting the gas supply (7) as a function of the feed speed (v_{w}), in particular for automatically setting a hydrodynamic dynamic pressure (p_{d}) of the gas flow (G) provided by the gas supply (7) as a function of the feed speed (v_{w}) according to a method as claimed in claim 1.

13. The device (1) as claimed in claim 7, characterized in that the laser source has a laser power of at least 3 kW.

14. The device (1) as claimed in claim 7, characterized in that the laser source is designed to provide laser radiation (L) having a wavelength of less than 10 μm, in particular less than 5 μm, preferably less than 2 μm, particularly preferably between 350 nm and 1300 nm.
